(19) United States
(12) Patent Application Publication
(10) Pub. No.: US 2012/0103029 A1
(43) Pub. Date: May 3, 2012

(54) APPAREL HOLDING SYSTEM, APPAREL HOLDING DEVICE FOR WASH/DRY CYCLE, METHOD OF FABRICATING APPAREL HOLDING DEVICE FOR WASH/DRY CYCLE

(76) Inventors: Kimberly A. DARWIN, Gilbert, AZ (US); Charles Joseph KOEHLER, Oklahoma City, OK (US)

(21) Appl. No.: 12/915,728

(22) Filed: Oct. 29, 2010

(51) Int. Cl. D06F 39/00; B29C 45/00

(52) U.S. Cl. 68/235 R; 264/328.1

(57) ABSTRACT

In an apparel washing device configured for a wash/dry cycle, a ring member having a thickness, width and a central opening there through is provided. A plurality of slotted openings are formed in the ring member in spaced relation thereof and arranged around the ring member. Each slotted opening is bisected on one side to form a pair of opposed flexible flange members that permit the insertion of apparel items there through.

### BACKGROUND

1. Field

Example embodiments in general are related to an apparel washing system, an apparel holding device for a wash/dry cycle, and a method of making an apparel holding device for a wash/dry cycle.

2. Related Art

Typically, apparel or garments such as socks can become lost between a wash cycle and a drying cycle in a laundry. Within washing and drying units, conventional apparel holding systems or washing systems comprising clips configured to hold the socks can become lost in the laundry during the washing and drying process; e.g., the garments or articles become separated from the very clips designed to hold them. Additionally, conventional hanging systems are separate from the apparel systems used within the wash-dry cycles of an automatic laundry. A conventional apparel washing system is directed to a garment retainer device that is useable in a washer/dryer cycle for retaining garments such as a pair of socks or other paired items during wash and dry cycles. The retainer device typically includes a plastic circular disc with a circular opening and a plurality of equal spaced slots extending radially outward from the central circular opening towards the outer periphery of the disc to provide a plurality of tabs. Paired garment items such as socks are inserted into the disc opening and pulled part way through the opening, causing the tabs between the slots to flex slightly upwardly in the direction of the insertion and thereby grip and lock the socks or clothing items tightly within the circular opening and ends of the tabs of the disc. The retainer device with socks is then laundered and dried together.

Another conventional apparel washing system is directed to a multipurpose holding device for retaining multiple garments during a washing cycle. In operation, a user attaches soiled paired garments to a fixing unit of the holding device by pushing a free flange of a secondary supporting formed piece through an opening of a primary supporting formed piece so that the secondary supporting formed piece is completely on the side of the primary supporting formed piece by an elastic connecting neck. The user positions the garment into the free opening defined by the primary and secondary supporting formed pieces, and then releases the secondary supporting formed piece. [No, we just cite refs in an IDS]

The elastic connecting neck “returns” the secondary supporting formed piece into its original position, and the garments with it, drawing garments into the opening of the primary supporting formed piece. The garments thus are joined together in pairs can be washed out, and hung up on a drying apparatus after cleaning with the aid of a suspension formed piece of the holding device. After drying, one can store the garments by hanging them up with the aid of the suspension formed piece until the time of use.

Another conventional apparel washing system is directed to a laundry organizer for use in a washer/dryer. The laundry organizer apparatus includes a support plate member defined by a perimeter edge. The plate member includes a convex bottom edge portion that includes a series of equally spaced apertures directed through the plate member adjacent the bottom edge portion.

A fastener is pivotally mounted within each aperture. Each fastener includes a spring biased clip defined by a first leg and a second leg biased apart relative to one another. The first leg is fixedly secured to a clasp body. The clasp body includes an “L” shaped leg projecting there from to receive the second leg there within. A free terminal end of the second leg includes a pointed projection to permit piercing of various garment portions such as socks when securing the garment portions and positioning them within a laundry organization.

The conventional apparel washing systems described, however, are not configured for stowage upon completion of the wash/dry cycle with clean garments thereon, via an integral hanger into a suitable storage facility such as a closet.

### SUMMARY

An example embodiment is directed to an apparel holding system for a wash/dry cycle. The system includes a ring member having a thickness, width and a central opening there through, and a plurality of slotted openings formed in the ring member in spaced relation thereof formed around the ring member. Each slotted opening is bisected on one side to form a pair of opposed flexible flange members that permit the insertion of apparel items there through. The system includes a connector, with the ring member and connector adapted to be coupled to one another.

Another example embodiment is directed to an apparel holding device for a wash/dry cycle. The device includes a ring member having a thickness, width and a central opening there through, and a plurality of slotted openings formed in the ring member in spaced relation thereof and arranged around the ring member. Each slotted opening is bisected on one side to form a pair of opposed flexible flange members that permit the insertion of apparel items there through.

Another example embodiment is directed to a method of fabricating an apparel holding device for a wash/dry cycle. The method includes providing a mold containing one or more product cavities, the product cavity including features comprising at least a ring member having a thickness, width and central opening there through, a plurality of slotted openings formed in the ring member in spaced relation thereof and arranged around the ring member, each elliptical slotted opening bisected on one side to form a pair of opposed flexible flange members. The mold is mounted on an injection molding machine. Plastic materials are then forced into the created mold on the injection molding machine to form the apparel holding device components.

### DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments.

FIG. 1 is a front view of an apparel holding system for a wash/dry cycle in accordance with an example embodiment

FIG. 2 is a front view of the system of FIG. 1 installed on a laundry hamper.

FIG. 3 is a plan view of the ring member of FIG. 1 installed on a hanging bar in a closet FIG. 4 is a flow chart illustrating a method of fabricating an apparel holding device according the example embodiments.

FIG. 5 is a plan view of an apparel holding device for a wash/dry cycle in accordance with another example embodiment.

FIG. 6 is a front view of the hanger element shown in FIG. 5.

FIG. 7 is a front view of an apparel holding device for a wash/dry cycle in accordance with another example embodiment.

FIG. 8 is a front view an apparel holding device for a wash/dry cycle in accordance with another example embodiment showing stowage and secured positions for a wash-dry cycle respectively.

FIG. 9 is a front view of an apparel washing system in accordance with another example embodiment.

FIG. 10 is a side view of the system of FIG. 9.

FIG. 11 is a flow chart illustrating a method of making the apparel holding system of FIG. 9 for a wash/dry cycle.

### DETAILED DESCRIPTION

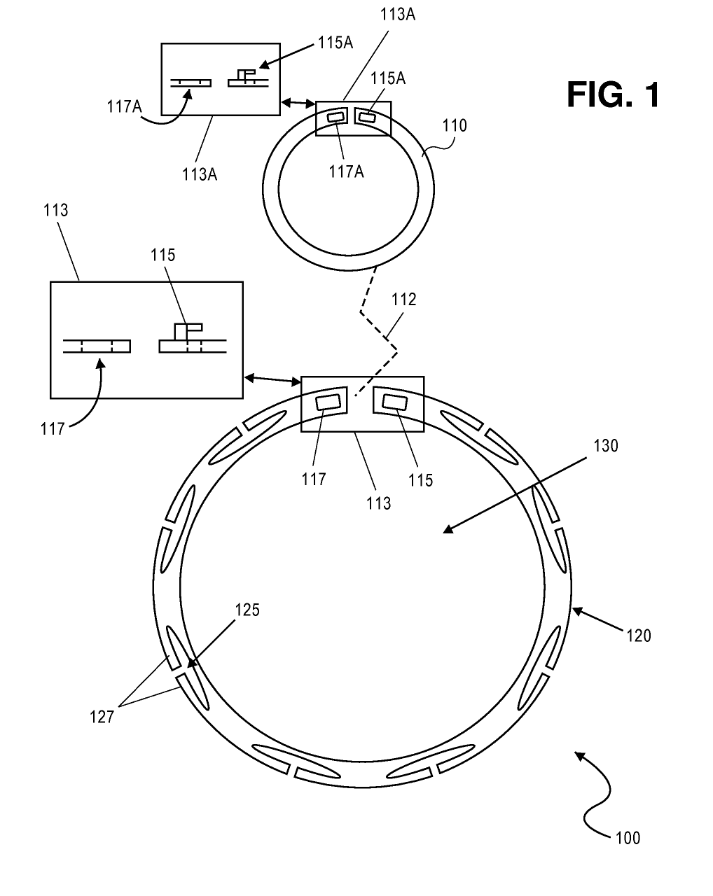

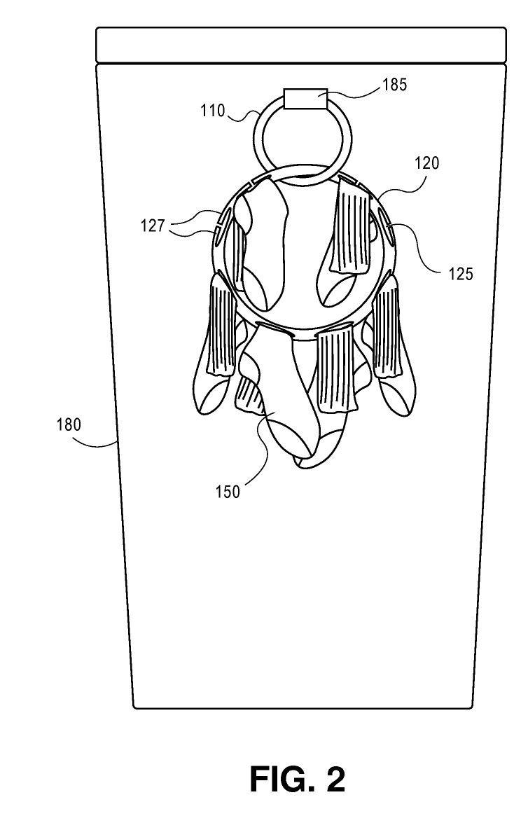

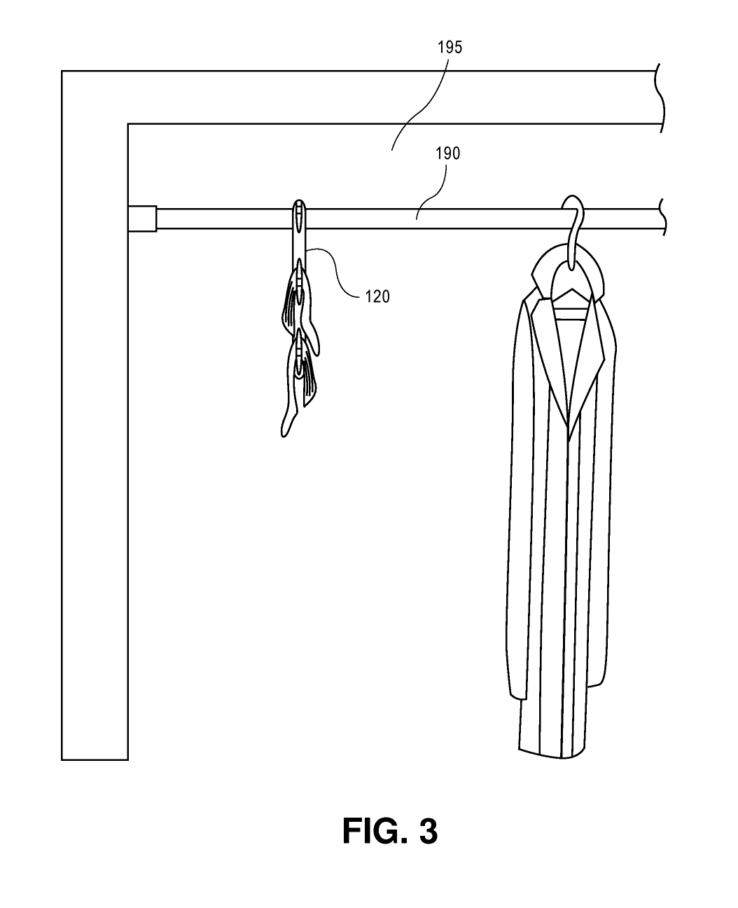

As used hereafter, the term “connector” refers to a constituent component configured for use with, coupled to, and/or integral with a ring member so that an apparel holding system or device encompassing the ring member may be removably attached to external structure such as a laundry hamper, closet hanging bar, and the like. FIG. 1 is a front view of an apparel washing system in accordance with an example embodiment; FIG. 2 is a plan view of the system of FIG. 1 installed on a conventional laundry hamper; and FIG. 3 is a plan view of the ring member of FIG. 1 installed on a hanging bar in a closet. Referring to FIGS. 1-3, system 100 includes a connector, referred to in these figures as a secondary ring element 110 that is removably attachable (as shown via dotted line 112) to a ring member 120 via a locking mechanism 113. The ring member 120 has a thickness and a width and a central opening 130 there through. The locking mechanism 113 comprises a generally L-shaped boss 115 that engages a slot 117 formed into ring 120 in snap-fit or interference fit relation to secure ring member 120 to the secondary ring element 110.

In a similar fashion, the secondary ring element 110 is removably attachable to a structural element on a laundry hamper 180 or to a structure in a storage location such as a hanging bar 190 in a closet 195 via a locking mechanism 113A. The locking mechanism 113A comprises a generally L-shaped boss 115A that engages a slot 117A formed into hanger element 110 in snap-fit or interference fit relation to secondary ring element 110 to a structural component 185 of a hamper 180 or a hanging bar 190 in a closet 195.

In a working example only, an outside diameter of the ring member 120 can be about 8.0 inches, and the secondary ring element 110 can have an outside diameter of about 3.0 inches. In a working example only, the thickness of rings 110/120 may be at least about 0.25 inches to about 0.50 inches; the width of ring member 120 is at least about 0.75 to 1.0 inches, and that of the secondary ring element at least about 0.50 to 0.75 inches. However the actual dimensions of the secondary ring element 110 and ring member 120 may vary, depending on the targeted clothing application.

The secondary ring element 110 and/or ring member 120 may be made primarily from a lightweight, durable material such as moldable plastic. In an example, the secondary ring element 110 and/or ring member 120 may be formed by an injection molding process from a high impact plastic, such as a thermoplastic or thermoplastic elastomeric resin. One example is Acrylonitrile Butadiene Styrene (ABS), which is a tough, low cost thermoplastic material with high impact strength. ABS is merely an example material, equivalent materials may include other thermoplastic and thermoset materials, including but not limited to talc-filled polypropylene, high strength polycarbonates such as GE Lexan®, or blended plastics.

There are many known injection molding machines for forming plastic injection molds, other plastic molding processes such as vacuum forming may be used. Alternatively, secondary ring element 110 and/or ring member 120 may be formed using a metal casting process such as sand casting, die casting, or investment casting, for example.

In a variation, to enhance gripping and/or ergonomics a portion of or all of the outer surface of the secondary ring element 110 and/or ring member 120 may include a rubber over mold to provide an ergonomic design for gripping by the hand/fingers of a user's hand. This may facilitate the user to more easily grip the secondary ring element 110 and/or ring member 120.

The ring member 120 includes a plurality of through-hole or slotted openings 125 in spaced relation thereof formed around the ring member 120. In an example, the slotted opening 125 could be formed around an outer periphery of the ring member 120; alternatively the slotted opening 125 could be formed toward an inner side of ring member 120. In one example, these slotted openings 125 may have a generally elliptical or ovular shape, as shown. However, the example embodiments foresee slotted openings 125 oriented in shapes other than elliptical or oval as well.

Each of the slotted openings 125 has one side bisected to form a pair of opposed flexible flange members 127 that permit the insertion of apparel items there through. The opposed flange members 127 form part of the ring member 120. The flange members 127 may be formed on either side of ring member 120 (outside or inside); thus a slotted opening 125 may be bisected on either side, or slotted openings 125 may alternate bisection on opposite sides of the ring member 120 around the circumference thereof, forming flange members 127. As best shown in FIG. 2, apparel items or garments 150 may be in the form of smaller apparel items such as socks, small underwear, T-shirts etc.

The opposed flange members 127 are resilient yet impart flexibility so as to hold the garment 150 within its opening 125 through the duration of a wash/dry cycle. In operation, the system 100 may be attached to the hamper 180 (such as to a structural component 185 via secondary ring element 110), and dirty garments 150 may be inserted into the slotted openings 125 and retained therein by opposed flange members 127.

Prior to insertion of the ring member 120 into the washer, the locking mechanism 113 is opened (boss 115 removed from slot 117), so that the ring member 120 can be removed from the secondary ring element 110 (and/or hamper 180), or the closet hanger bar 190. The user has thus inserted selected garments 150 (here pairs of soiled socks) into the openings 125. The ring member 120 with soiled garments is then ready to be placed into the washer.

Cleaning agents are added, the wash cycle is set and washing proceeds. At the completion of the wash cycle, ring member 120 is removed and placed in the dryer. The drying cycle is set and initiated. Alternatively, ring member 120 can be attached to an open air drying line. After completion of the set drying time, the garments 150 and ring member 120 are removed from the dryer or drying line. The ring member 120 can be reattached to secondary ring element 110 via locking mechanism 113 for hanging into a suitable storage compartment, such as on hanging bar 190 in closet 195. Alternatively and as shown in FIG. 3, ring member 120 can be directly attached to a structure such as hanging bar 190 without the use of secondary ring element 110.

FIG. 4 is a flow chart illustrating a method of fabricating an apparel holding device according the example embodiments. It is anticipated that the connector (such as the secondary ring element 110) and/or ring member 120 will be injection-molded formed in two separate pieces, with molds incorporating one or more product cavities.

In method 400, a product design is provided (S410) to create a mold containing one or more product cavities. More specifically, in using the product design provided at S410 all of the product features are machined into the mold, creating one or more product cavities (S420). Additional cavities for other components may be contained in the eventual mold, or additional molds may be created. For example, for the ring member 120, this includes forming all of the openings 125, slots to form the opposed flange members 127, forming the slot that separates ends of ring member 120 into upper opposed ends, indentions to form the slot 117, and bump-out to form boss 115 of locking mechanism 113. A separate product cavity may be prepared for secondary ring element 110 as described above. All the slots and ring/flange features are thus included in the product cavities. Alternatively, in an embodiment where no secondary ring element 110 is included and the ring member 120 is hung by other means, a product cavity can be set for a continuous ring member 120 with no break at the top end (i.e., no gap), thus obviating any need for locking mechanism 113.

The molds (for secondary ring element 110 and ring member 120, or ring member 120 alone) are then mounted (S430) on an injection molding machine. The selected plastic material for the system 100 is forced into the mold product cavities within the injection molding machine (S440), and a secondary ring element 110 and ring member 120 that forms the system 100 is created.

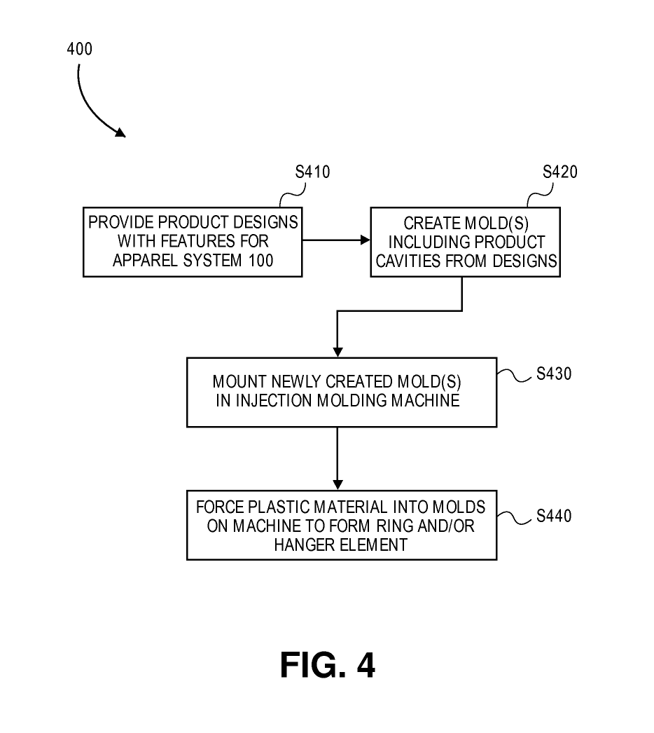

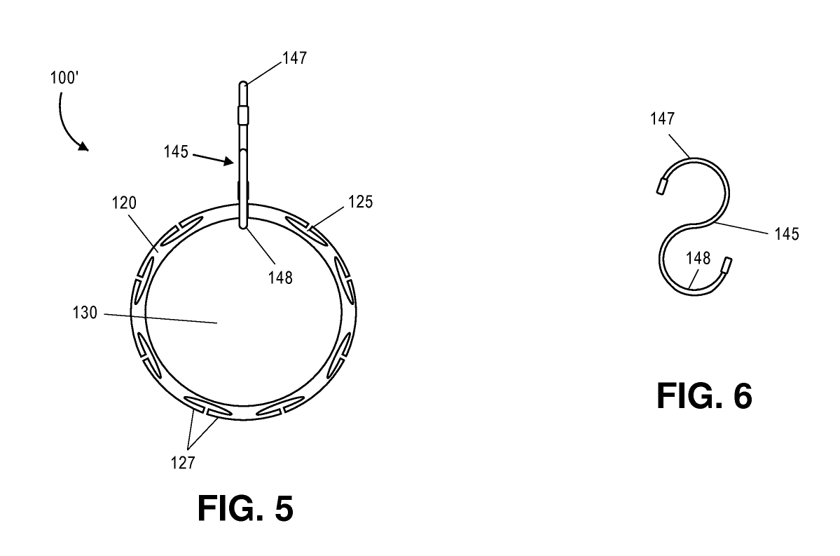

FIG. 5 is a plan view of an apparel holding device for a wash/dry cycle in accordance with another example embodiment; FIG. 6 is a front view of an optional hanger element useable with the device of FIG. 5. As many constituent components of FIG. 5 are similar to that shown in FIG. 1, only the differences are noted in detail.

In FIG. 5, the apparel washing device 100′ does not require locking mechanism 113; rather it is composed of a circular ring member 120 with no break at the top. As in FIG. 1, the ring member 120 includes the slotted openings 125 in spaced relation around an outer periphery thereof, with each of the openings 125 having one side bisected to form the opposed flexible flange members 127 that permit the insertion of apparel items there through.

The apparel washing device 100′ has a central opening 130 and may in one example have an outer diameter of approximately 8″. Additionally, in one construction, if a user desires to hang device 100′ on a hamper or hanging rod (such as shown in FIGS. 2 and 3), another type of connector, embodied in the form of a hanger element 145 may be employed in conjunction with device 100′. In an example, hanger element 145 is formed in an “S” shape so as to be able to grasp both the device 100′ and a structural element on a hamper or in a closet (i.e., hanging bar). In one example, hanger element 145 may have a height of approximately 4-5 inches and be dimensioned so that curved portions 147 or 148 fit over a standard clothes hanging bar.

Device 100′ and hanger element 145 may be fabricated from the same materials previously outlined for system 100 and by the methodology outlined in FIG. 4. The operation of using device 100′ is similar to that of FIG. 1 without use of locking mechanisms 113/113A.

Although system 100 and device 100′ are shown with a generally circular ring member 120, the example embodiments are not so limited to a member 120 that is circular in form. Member 120 can take on alternative shapes within the scope of the example embodiments herein. Moreover, the shape of the slotted opening 125 may be varied to a design other than that shown in FIGS. 1-5, for example so as to secure a garment 150 therein.

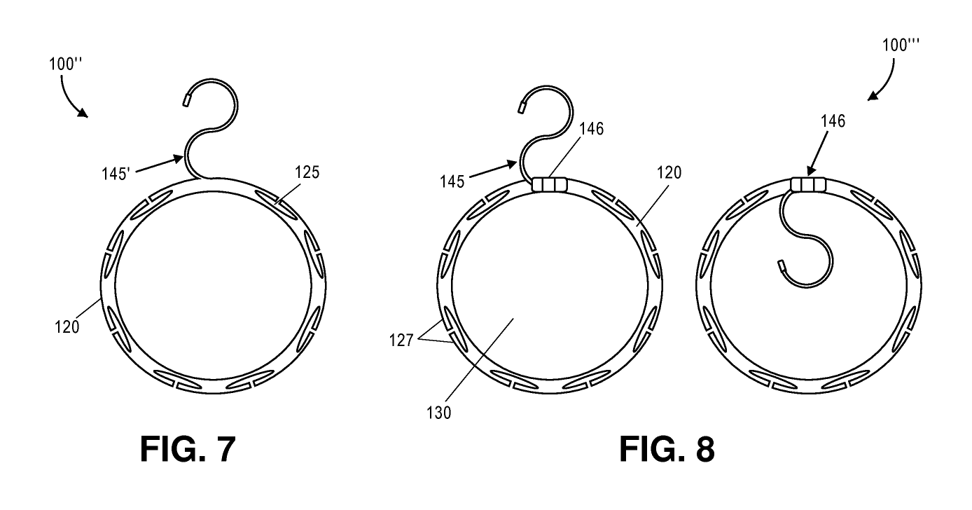

FIG. 7 is a front view of an apparel holding device for a wash/dry cycle in accordance with another example embodiment. As many constituent components of FIGS. 1 and 5 are similar to that shown in FIG. 7, only the differences are noted in detail.

In FIG. 7, an apparel washing device 100″ includes a ring member 120 integral with an integral connector component, shown in FIG. 7 as a modified hanger element 145′, so as to provide a single injection molded part. Device 100′ and modified hanger element 145′ may be fabricated from the same materials previously outlined for system 100 and by the methodology outlined in FIG. 4.

The operation of using device 100″ is slightly different to that of FIGS. 1 and 5 in that a connector is integral therewith through both wash and dry cycles. Thus, any cleaned garments 150 thereon can be immediately positioned for stowage if desired via modified hanger element 145′.

FIG. 8 is a front view of an apparel washing system in accordance with another example embodiment showing both stowage and secured positions for a wash-dry cycle respectively. As many constituent components of FIGS. 1, 5 and 7 are similar to that shown in FIG. 8, only the differences are noted in detail.

Unlike FIG. 7, the connector for the apparel washing device 100′″ includes a pivot member 146 enabling hanger element 145 to rotate to a secured position just prior to inserting the device 100′″ with soiled garments into a wash cycle. This may reduce stresses on the hanger element 145 during the wash and/or dry cycles. Device 100′″ may be fabricated from the same materials previously outlined for the previous embodiments and by the methodology outlined in FIG. 4, with additional forming steps at the product cavity stage for the pivot member 146 and some after shot assembly to secure the hanger element 145 therein. The operation of using device 100′″ is slightly different to previous embodiments in that the hanger element 145 is both rotatably connected to the ring member (via pivot member 146) and pivotable between two positions.

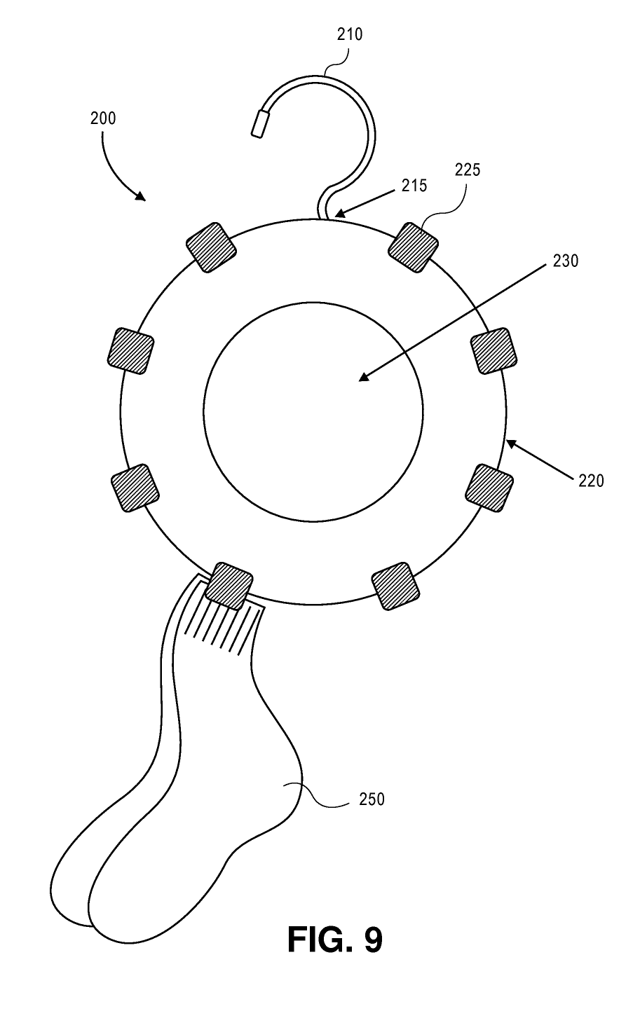

FIG. 9 is a front view of an apparel washing system in accordance with another example embodiment. System 200 includes a swiveling or collapsible hanger 210 configured to have a fold-down capability for the wash and dry cycles of a manual wash/hang dry or an automatic washer/dryer system, for example. Hanger 210 is connected at a pivot point 215 to a ring member 220. The ring member 220 includes a plurality of fasteners 225 in spaced relation thereof on an outer surface of the ring member 220 along an outer circumference thereof. The ring member 220 has a thickness and a central opening 230 so as to have a generally “doughnut-shape”, for example. Each of the fasteners 225 may be configured to releasably secure an article of clothing or garment 250 thereto. As shown for explanatory purpose only, garment 250 is a pair of socks.

In a working example only, an internal diameter of the ring member can be about 8.5 inches and an external diameter can be about 11 inches. The ring member 220 may be made primarily from a lightweight, durable material such as moldable thermoplastic; example materials being any of ABS, Virgin ABS mixed with other plastic components, talc-filled polypropylene, polycarbonates, blended plastics, etc.

As in the previous embodiments, a portion of or all of the outer surface 223 of the ring member 220 may include a rubber over mold to provide an ergonomic design for gripping by the hand/fingers of a user's hand. This may facilitate the user to more easily grip the ring member 220.

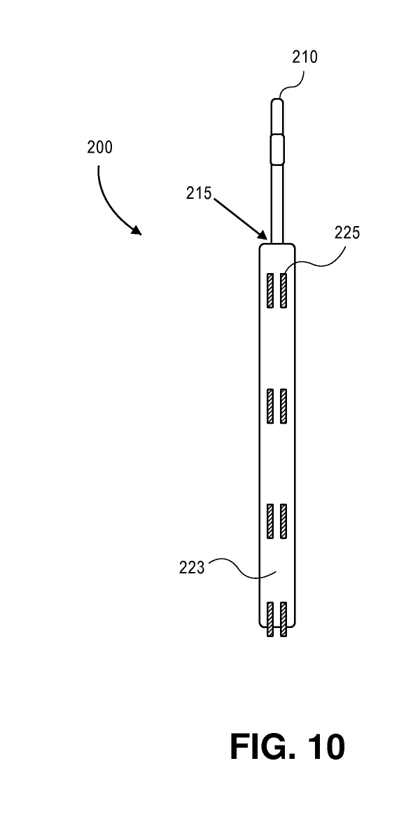

FIG. 10 illustrates a side view of the system of FIG. 9. The fasteners in one example may be embodied by a plurality of clips 225 extending outward from outer surface 223 of the ring member around a circumference thereof. In an example, a thickness of the ring member 220 can be about ¾ inch.

In one example, the clips 225 may be detachable from the outer surface 223 of the ring member 220, i.e., the clips 225 are removable from surface 223 of ring member 220. In one configuration, each clip 225 can be configured with a male connector that is designed for a ‘snap-fit’ or interference fit connection with a corresponding female connector or bore within the surface 223 on ring member 220. Alternatively, this can be a lock/twist configuration as is known; or a hook and loop engagement, the details of which are omitted herein for purposes of brevity.

In another example, the clips 225 are integrally formed as part of the ring member 220 and of the same materials as described above. In an alternative, the fasteners may be embodied as metal springs 225 instead of metal or plastic clips 225.

The following describes an example use of the system 200 and/or device within the context of a wash/dry cycle. The apparel for the following example is a pair of socks; it being understood that system 200 is applicable to any garment or apparel that can be subject to a wash/dry cycle.

In operation, prior to insertion of the ring 220 into the washer, the user has connected selected garments 140 (here pairs of soiled socks) to the fasteners 225. For example, the ring member 120 with garments 250 may be retrieved from a clothes hamper of soiled garments. The hanger 210 is folded down at its pivot point 215 and then the ring member 120 is placed into the washer.

Cleaning agents are added, the wash cycle is set and washing proceeds. At the completion of the wash cycle, system 200 is removed and placed in the dryer. The drying cycle is set and initiated. After completion of the set drying time, the clean garments 250 of system 200 are removed from the dryer, the hanger 210 is pivoted upward to a stow position, and the system 200 can be hung in a suitable storage compartment such as a closet.

In one example, the materials composing the apparel washing systems 100 and/or 200 are configured to withstand up to about at least a thousand washer and hot dryer cycles.

Accordingly, the example apparel holding system 200 for a wash/dry cycle includes a ring member 200 having a thickness and a central opening 230 there through, a pivotable hanger 210 coupled to the ring member 220, and a plurality of fasteners 225 arranged in spaced relation on an outer surface 223 of the ring member 220 around a circumference thereof. Each fastener 225 is configured to secure at least one garment 250 thereto during a wash/dry cycle so that the garment 250 remains attached. The system 200 with cleaned garments 250 attached thereto may be configured to be stowed in a stowage facility via the hanger 210 upon completion of the wash/dry cycle.

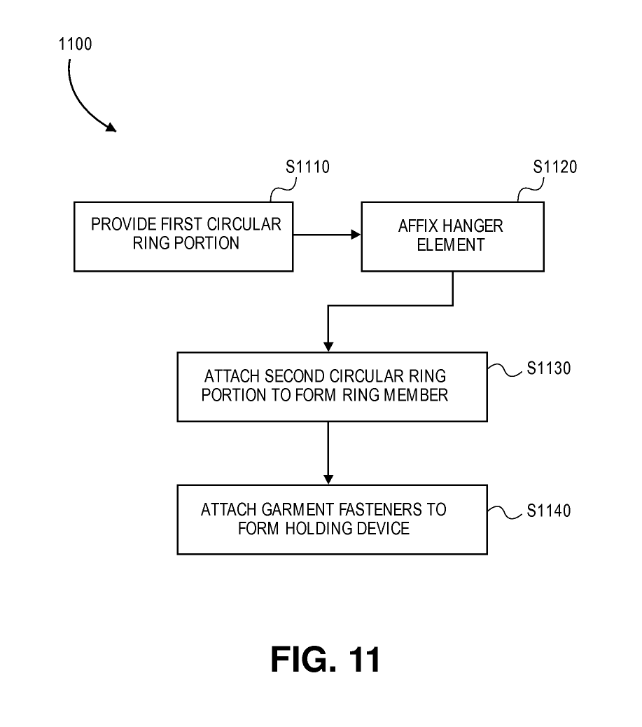

FIG. 11 is a flow chart illustrating a method of making an apparel holding device usable in a wash/dry cycle, according the example embodiments. The method illustrates the system/device embodiments shown in FIGS. 9 and 10. Referring to FIG. 11, the method 1100 includes initially providing a first circular ring portion (S1110), affixing a pivotable hanger element (S1120) to the first ring portion, and attaching a second circular ring portion (S1130) to the first ring portion so as to form a generally doughnut-shaped ring member having a thickness. A plurality of garment fasteners are then attached (S1140) in spaced relation to an outer surface of the ring member around an outer circumference thereof to form the apparel holding device. Each of the garment fasteners is configured to secure one or more garments thereto during a wash/dry cycle. Upon completion of the wash/dry cycle, the apparel holding device with clean garments attached thereto can be stowed, via the hanger, in a suitable storage facility such as a closet.

Thus, in a method of making an apparel holding device for a wash/dry cycle, a first circular ring portion is provided, and a pivotable hanger element 210 is affixed to the first ring portion. A second circular ring portion is attached to the first ring portion so as to form a ring member 220 having a thickness, and a plurality of garment fasteners 225 are attached to an outer surface 223 of the ring member 220 to form the apparel holding device 200.

The example embodiments being thus described, it will be obvious that the same may be varied in many ways. Such variations are not to be regarded as departure from the spirit and scope of the example embodiments, and all such modifications as would be obvious to one skilled in the art are intended to be included within the following claims.

We claim:

1. An apparel holding system for a wash/dry cycle, comprising:
a ring member having a thickness, width and a central opening there through,
a plurality of slotted openings formed in the ring member in spaced relation thereof formed around the ring member, each slotted opening bisected on one side to form a pair of opposed flexible flange members that permit the insertion of apparel items there through, and
a connector, the ring member and connector adapted to be coupled to one another.

2. The system of claim 1, wherein the ring member is separated at a location to form a locking mechanism between the opposed separated ends so that the ring member can be separated from the connector or another structure.

3. The system of claim 2, wherein the locking mechanism comprises a boss on one of the separated ends which mates with a slot formed in the other separated end to secure the ring member to the connector or another structure.

4. The system of claim 1, wherein the connector is embodied as a secondary ring element that is separated at a location thereon creating opposed ends, the connector including a locking mechanism between the opposed separated ends so that the secondary ring element can be separated from the ring member or another structure.

5. The system of claim 4, wherein the locking mechanism comprises a boss on one of the separated ends which mates with a slot formed in the other separated end to secure the secondary ring element to the ring member or another structure.

6. The system of claim 1, wherein the connector is embodied as an S-shaped hanger element, with one of the curved portions hooking the ring member and the other of the curved portions adapted for grasping another structure including at least a laundry hamper and a closet hanging bar.

7. The system of claim 1, wherein the hanger element is integrally formed as part of the ring member.

8. The system of claim 1, wherein the connector is embodied as a hanger element pivotally attached to the ring element at one end thereof so as to be pivotable downward into a secured position prior to inserting the system with soiled garments into a wash cycle.

9. An apparel holding device for a wash/dry cycle, comprising:
a ring member having a thickness, width and a central opening there through, and
a plurality of slotted openings formed in the ring member in spaced relation thereof and arranged around the ring member, each slotted opening bisected on one side to form a pair of opposed flexible flange members that permit the insertion of apparel items there through.

10. The device of claim 9, wherein the ring member is separated at a location to form a locking mechanism between the opposed separated ends so that the ring member can be attached and separated from another structure.

11. The device of claim 9, wherein the opposed flexible flange members are an integral part of the ring member.

12. The device of claim 9, further comprising:
a circular secondary ring element separated at a location to form a locking mechanism between the opposed separated ends so that the secondary ring element can be separated from the ring member or another structure.

13. The device of claim 9, further comprising:
an S-shaped hanger element, with one of the curved portions adapted to hook the ring member and the other of the curved portions adapted for grasping another structure.

14. The device of claim 13, wherein the hanger element is integrally formed with the ring member.

15. The device of claim 13, wherein the hanger element is pivotally attached to the ring element at one end thereof so as to be pivotable downward into a secured position prior to inserting the system with solied garmets into a wash cycle.

16. A method of fabricating an apparel holding device for a wash/dry cycle, comprising:
providing a mold containing one or more product cavities, the product cavity including features comprising at least a ring member having a thickness, width and central opening there through, a plurality of slotted openings formed in the ring member in spaced relation thereof and arranged around the ring member, each slotted opening bisected on one side to form a pair of opposed flexible flange members,
mounting the mold on an injection molding machine, and
forcing plastic materials into the created mold on the injection molding machine to form the apparal holding device.
